(19) United States
(12) Patent Application Publication
(10) Pub. No.: US 2010/0305901 A1
(43) Pub. Date: Dec. 2, 2010

(54) Systems and Methods of Determining and Correlating Technical Information for Wheel Repairs

(76) Inventor: Robert G. Stretch, Arlington, TX (US)

Correspondence Address: Klemchuk Kubasta LLP, 8150 N Central Expressway, SUITE 1150, DALLAS, TX, 75206, US

(21) Appl. No.: 12/471,868

(22) Filed: May 26, 2009

(51) Int. Cl. G01B 21/08; G06F 15/00; G06F 17/30; G06F 3/048; G06N 5/02

(52) U.S. Cl. 702/170; 715/700; 707/E17.01; 706/54

(57) ABSTRACT

The present disclosure generally provides systems and methods of determining technical data for wheels and wheel repairs. The system and method could include a graphical user interface (GUI) to input data associated with a wheel. The input data could include information associated with outer and inner radial thicknesses of the wheel, outer and inner lateral thicknesses of the bead, outer and inner diagonal thicknesses of the wheel, outer and inner surface run-out measurements of the wheel, other suitable information related to the wheel, other suitable information, or any combination thereof. The system could further include a network having a database to store the inputted data and having control data associated with wheels. The system could still further include a processor in communication with the database to correlate the input data with the control data and to determine the reparability of the used wheel.

### TECHNICAL FIELD

The present disclosure generally relates to measuring and reporting systems and, in particular, to such systems in the wheel industry.

### BACKGROUND

A tire is typically mounted about a wheel made of a lightweight metal or metal alloy, such as aluminum, magnesium, and titanium. From time to time, these wheels require certain maintenance or repair after they have been in use for some time or are disfigured by, for example, contact with a curb, pothole, or the like. There is a need for systems and methods of determining and correlating technical information related to the integrity and general reparability of such wheels in an effective, efficient, and cost-sensitive manner.

### SUMMARY

Embodiments of the present disclosure generally provide systems and methods of determining and correlating technical information for wheel repairs.

In one embodiment, the present disclosure generally provides a system of repairing a wheel. The system could include a terminal to input data associated with a bead of the wheel. The system could also include a processor to correlate the inputted data with control data stored in a database. The processor could determine the reparability of the wheel based on the correlated data.

In one embodiment, the present disclosure generally provides a method of determining the reparability of a wheel. The method could include determining the control data associated with a bead of the wheel. The method could also include measuring technical data associated with a surface of the wheel and the bead. The method could further include comparing the control data with the measured technical data. The method could still further include determining the reparability of the wheel based on the comparison.

In one embodiment, the present disclosure generally provides a system of determining the reparability of a wheel. The system could include a graphical user interface (GUI) to input data associated with the wheel. The input data could include information associated with a lateral thickness of a bead of the wheel and a surface run-out measurement of the wheel. The system could also include a network having a database to store the inputted data and having control data associated with the wheel. The system could further include a processor in communication with the database to correlate the input data with the control data and to determine the reparability of the wheel.

Other technical features may be readily apparent to one skilled in the art from the following figures, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 is a somewhat simplified illustration of a system and method of determining and correlating technical information for wheel repairs according to one embodiment of the present disclosure;

FIG. 2A is a somewhat simplified illustration of a wheel according to one embodiment of the present disclosure;

FIG. 2B is a cross-sectional view of the wheel shown in FIG. 2A according to one embodiment of the present disclosure;

FIG. 2C is a cross-sectional view of the wheel shown in FIG. 2A illustrating inner and outer radial thickness measurements according to one embodiment of the present disclosure;

FIG. 2D is a cross-sectional view of the wheel shown in FIG. 2A illustrating inner and outer lateral thickness measurements according to one embodiment of the present disclosure;

FIG. 2E is a cross-sectional view of the wheel shown in FIG. 2A illustrating inner and outer diagonal thickness measurements according to one embodiment of the present disclosure;

FIG. 2F is a cross-sectional view of the wheel shown in FIG. 2A illustrating inner and outer surface run-out measurements according to one embodiment of the present disclosure;

FIG. 3 is a somewhat simplified illustration of a graphical user interface (GUI) showing an example list of wheels associated with a particular wheel currently in an exemplary database according to one embodiment of the present disclosure;

FIGS. 4A-4C are somewhat simplified illustrations of a GUI used to enter various technical information for a desired wheel according to one embodiment of the present disclosure; and

FIG. 5 is a somewhat simplified flow diagram illustrating a method of determining and correlating technical information for wheel repairs according to one embodiment of the present disclosure.

### DETAILED DESCRIPTION

The present disclosure generally provides systems and methods of correlating and conveying information related to the integrity and general reparability of such wheels in an effective, efficient, and cost-sensitive manner.

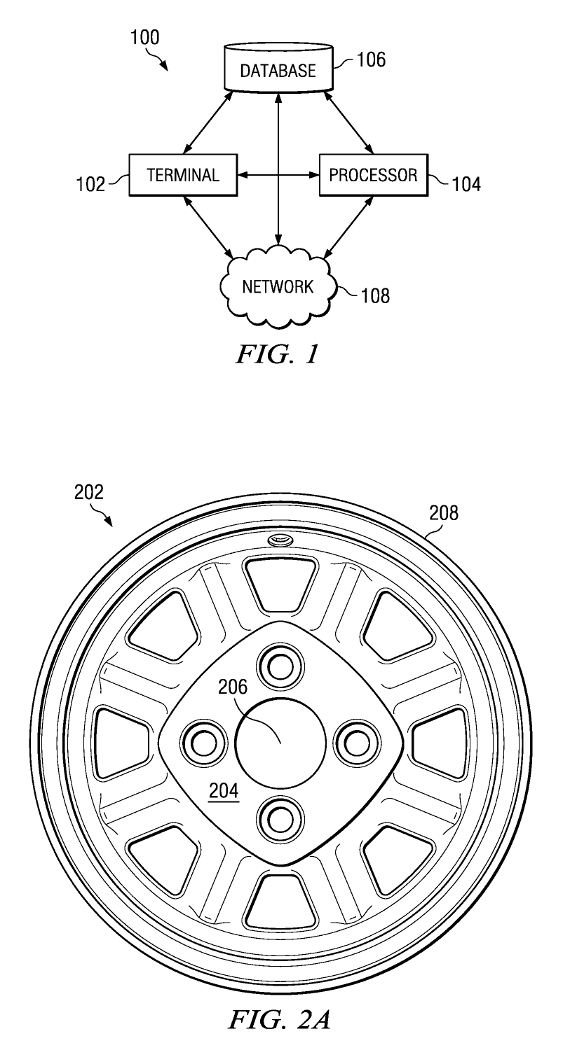

FIG. 1 is a somewhat simplified illustration of system 100 of FIG. 1 is a somewhat simplified illustration of system 100 determining and correlating technical information for wheel repairs according to one embodiment of the present disclosure. It should be understood that system 100 shown in FIG. 1 is for illustrative purposes only and that any other suitable system or subsystem could be used in conjunction with or in lieu of system 100 according to one embodiment of the present disclosure.

System 100 generally provides a system of inputting data related to a particular wheel and correlating such data to ascertain whether that wheel could be repaired. System 100 could include terminal 102, analyzer 104, database 106, and Internet 108. For example, a technician could input technical information about a particular wheel and system 100 could provide information related to the general integrity and reparability of the wheel in an effective, efficient, and cost-sensitive manner according to one embodiment of the present disclosure.

Terminal 102 could be any computer, stand-alone unit, networked device, terminal, console, mobile communication device, other suitable wireless or wire-line device, or any combination thereof. Terminal 102 could be communicably connected to analyzer 104, database 106, Internet 108, other parts of system 100, or any combination thereof. For example, terminal 102 could be communicably connected to other terminals, work areas, centralized location, franchises, and other locations/devices by a wire-line using a networked communication line, Intranet, Internet 108, or any combination thereof according to one embodiment of the present disclosure.

Terminal 102 provides an inputting and displaying device by which a user could input and have displayed certain measurements, observations, technical data, wheel related information, manufacturing information, other information, or any combination thereof. For example, terminal 102 could be used to input and display a variety of wheel-specific information such as, for example, information related to the manufacturer of the wheel, size/dimension of the wheel, manufacturing date, model name, serial number, radial thickness of a bead, lateral thickness of a bead, diagonal thickness of a bead, surface run-out information, diameter of the wheel, width of the wheel, any other suitable information, or any combination thereof. Additionally, although only one terminal 102 is illustrated in FIG. 1, it should be understood that any number of terminals could be associated with system 100 according to one embodiment of the present disclosure.

Processor 104 generally manages the data collected by system 100, stored in system 100, correlated in system 100, or any suitable combination thereof. Processor 104 could also correlate, compute, and analyze data associated with system 100 to provide certain technical data related to a wheel at hand, a set of wheels, wheels in a certain family or model of wheels, other suitable wheel related information, or any combination thereof according to one embodiment of the present disclosure.

Processor 104 could communicate with terminal 102, network 108, and database 106. Processor 104 could be any suitable processor, chip, chip set, memory, computer, stand-alone unit, networked device, terminal, console, mobile communication device, other suitable wireless or wire-line device, other suitable device, or any combination thereof. Additionally, although only one processor 104 is illustrated in FIG. 1, it should be understood that any number of processors could be associated with system 100 according to one embodiment of the present disclosure.

Database 106 could communicate with terminal 102, processor 104, network 108, or any combination thereof. In one embodiment, database 106 could be part of processor 104. Although database 106 is illustrated as generally a stand-alone unit, it should be understood that database 106 could be included as part of any suitable device, terminal (such as terminal 102), or network (such as network 108). In addition, database 106 could include any suitable organization of data according to one embodiment of the present disclosure.

In one embodiment, database 106 could include data for all wheels related to a particular shop, a group of shops, other terminals, work areas, centralized locations, franchises, and other locations/devices. Additionally, although only one database 106 is illustrated in FIG. 1, it should be understood that any number of databases could be associated with system 100 according to one embodiment of the present disclosure.

Network 108 could include any suitable communication network of particular shop, a group of shops, other terminals, work areas, centralized locations, franchises, and other locations/devices. Network 108 could be wireless network, a wire-line network, Internet-enabled network, Intranet-enabled network, or any suitable combination of networks. Although only one network 108 is illustrated in FIG. 1, it should be understood that any number of networks or sub-networks could be associated with system 100 according to one embodiment of the present disclosure.

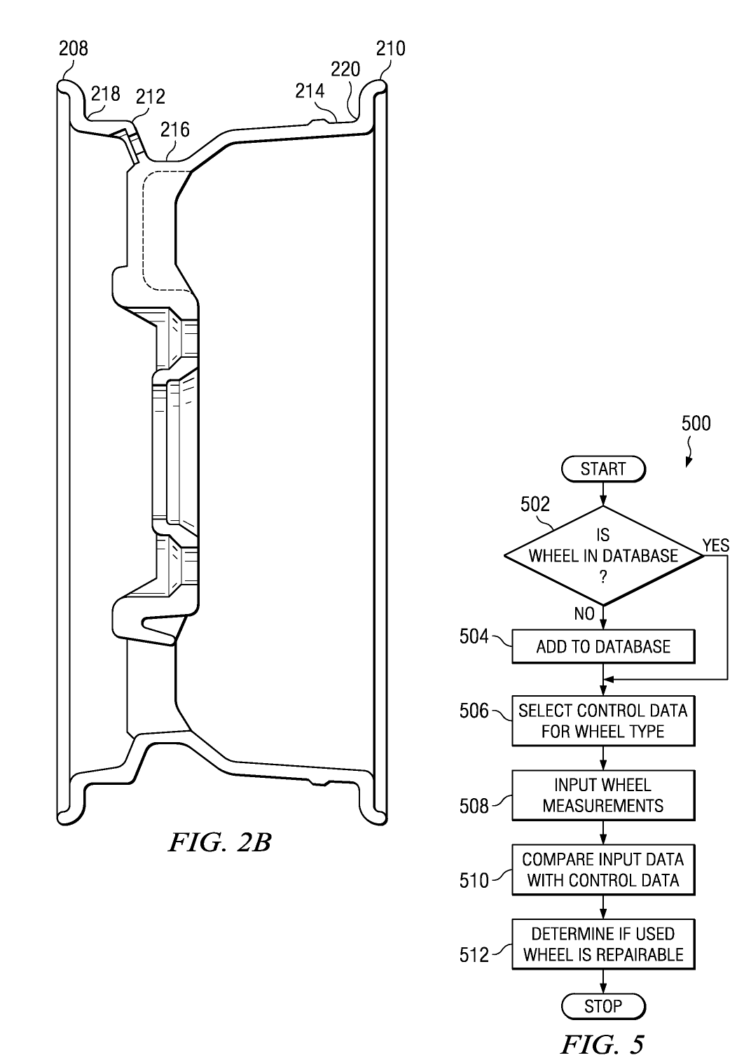

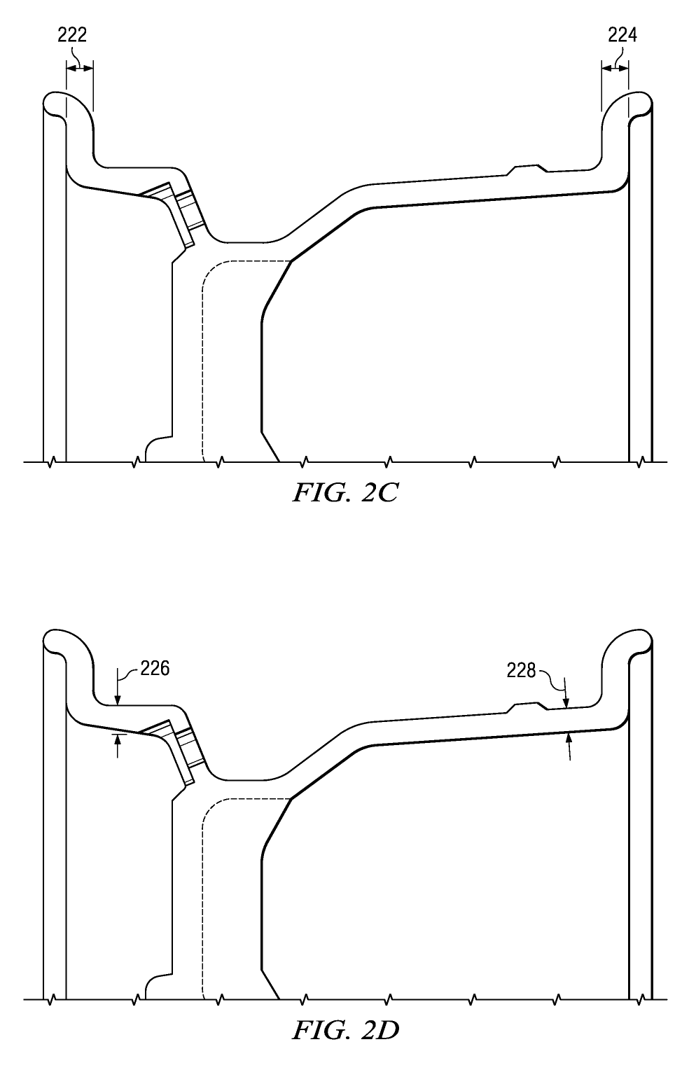

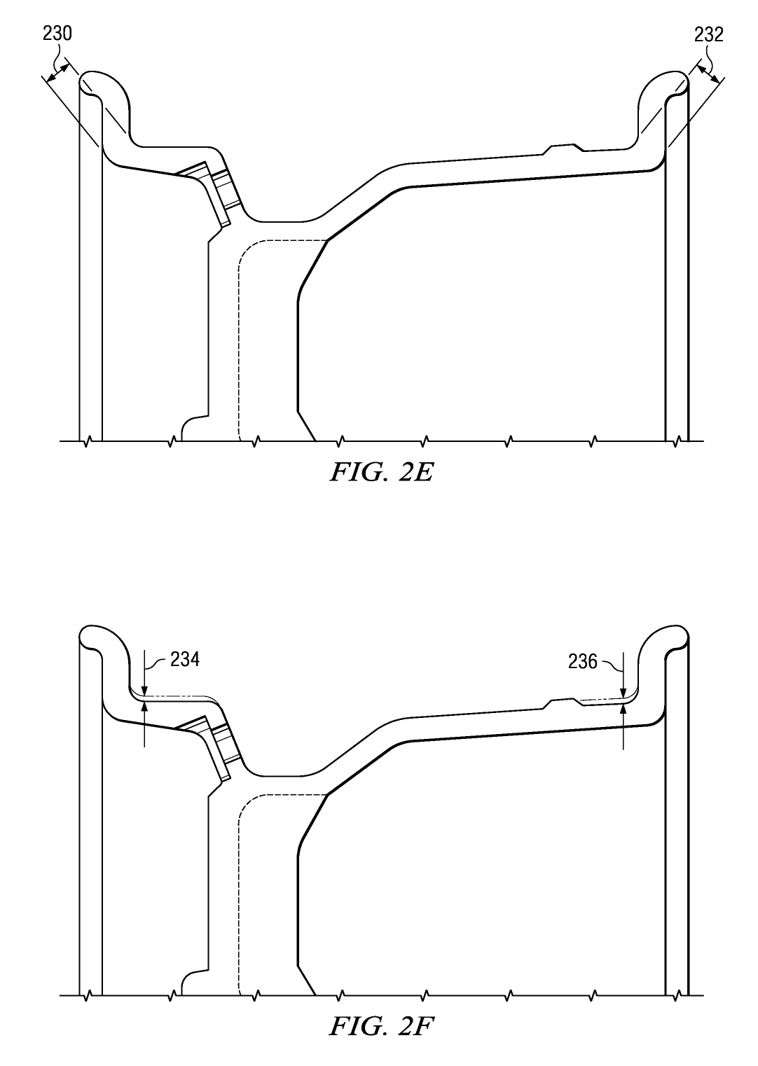

FIG. 2A is a somewhat simplified illustration of wheel 202 and FIG. 2B is a cross-sectional view of wheel 202 according to one embodiment of the present disclosure. It should be understood that wheel 202 shown in FIGS. 2A and B is for illustrative purposes only and that any other suitable wheel system or subsystem could be used in conjunction with or in lieu of wheel 202 according to one embodiment of the present disclosure.

Wheel 202 could aid in generally mounting a tire (not shown in FIGS. 2A or 2B) about a surface of wheel 202. Wheel 202 could include a lightweight metal or metal alloy, such as aluminum, magnesium, and titanium. Wheel 202 could be used in any suitable motor vehicle such as, for example, a truck, a straight truck, an articulated truck, small panel truck, medium-sized truck, large 18-wheeler truck, freight truck, cab, trailer, van, car, sports utility vehicle (SUV), bus, or any other suitable motor vehicle apparatus.

Wheel 202 could require certain surface treatments when they are manufactured and could require re-treatments after they have been in use for some time or are disfigured by, for example, contact with a curb, pothole, or the like. Wheel 202 therefore could require proper surface preparation, treatments, resurfacing, or some kind of reconditioning. According to one embodiment of the present disclosure, system 100 could aid in determining the amount, type, and availability of such treatments.

Wheel 202 could include outside surface 204, an inside surface (not shown in FIG. 2A), and center axis point 206. Outside surface 204 faces away from the vehicle in which wheel 202 is installed, while the inside surface of wheel 202 could face in an opposing direction and may not be visible when wheel 202 is installed on a vehicle. Wheel 202 could rotate about center axis point 206.

Wheel 202 could also include outer lip 208, inner lip 210, outside bead 212, inner bead 214, recessed area 216, outer seat 218, and inner seat 220. In one embodiment, a tire could generally be disposed about wheel 202 between outer lip 208 and inner lip 210. More specifically, a tire could be maintained in a particular position by having an outer flange of the underside of a tire situated between outer lip 208 and outside bead 212 and having an inner flange of the underside of a tire situated between inner lip 210 and inner bead 214.

FIGS. 2C, 2D, 2E, and 2F generally illustrate various measurements taken of elements of wheel 202 and are described in greater detail later herein. It should be understood that the various measurements could be taken with any suitable measuring device or other suitable mechanisms. For example, such measurements could be taken with Vernier calipers, digital Vernier calipers, dial calipers, dial indicator, gauges, feeler gauges, high precision instruments, modified rulers, scales, lasers, scanning tools, calibration tools, other suitable instruments, or any combination thereof.

FIG. 2C is a cross-sectional view of wheel 202 illustrating outer radial thickness 222 and inner radial thickness 224 measurements according to one embodiment of the present disclosure. It should be understood that outer radial thickness 222 and inner radial thickness 224 measurements shown in FIG. 2C are for illustrative purposes only and that any other suitable wheel measurements or relative measurements could be used in conjunction with or in lieu of outer radial thickness 222 and inner radial thickness 224 measurements according to one embodiment of the present disclosure.

In the embodiment shown in FIG. 2C, outer radial thickness 222 is generally a measurement of the thickness of outer lip 208. In one example, outer radial thickness 222 could be the distance between a proximate surface of outer lip 208 and a distal surface of outer lip 208. It should be understood that outer radial thickness 222 could be an average or mean value of several such measurements taken at different points about wheel 202 and outer lip 208, a maximum thickness measured, a minimum thickness measured, or some other correlated value related to such measurements.

Similarly, as also shown in FIG. 2C, inner radial thickness 224 is generally a measurement of the thickness of inner lip 210. In one example, inner radial thickness 224 could be the distance between a proximate surface of inner lip 210 and a distal surface of inner lip 210. It should be understood that inner radial thickness 224 could be an average or mean value of several such measurements taken at different points about wheel 202 and inner lip 210, a maximum thickness measured, a minimum thickness measured, or some other correlated value related to such measurements.

FIG. 2D is a cross-sectional view of wheel 202 illustrating outer lateral thickness 226 and inner lateral thickness 228 measurements according to one embodiment of the present disclosure. It should be understood that outer lateral thickness 226 and inner lateral thickness 228 measurements shown in FIG. 2D are for illustrative purposes only and that any other suitable wheel measurements or relative measurements could be used in conjunction with or in lieu of outer lateral thickness 226 and inner lateral thickness 228 measurements according to one embodiment of the present disclosure.

In the embodiments shown in FIGS. 2A and 2D, outer lateral thickness 226 is generally a measurement of the thickness of outer bead 212. In one example, outer lateral thickness 226 could be the distance between a proximate surface of outer bead 212 and a distal surface of outer bead 212. It should be understood that outer lateral thickness 226 could be an average or mean value of several such measurements taken at different points about wheel 202 and outer bead 212, a maximum thickness measured, a minimum thickness measured, or some other correlated value related to such measurements.

Similarly, as also shown in FIGS. 2A and 2D, inner lateral thickness 228 is generally a measurement of the thickness of inner bead 214. In one example, inner lateral thickness 228 could be the distance between a proximate surface of inner bead 214 and a distal surface of inner bead 214. It should be understood that inner lateral thickness 228 could be an average or mean value of several such measurements taken at different points about wheel 202 and inner bead 214, a maximum thickness measured, a minimum thickness measured, or some other correlated value related to such measurements.

FIG. 2E is a cross-sectional view of wheel 202 illustrating outer diagonal thickness 230 and inner diagonal thickness 232 measurements according to one embodiment of the present disclosure. It should be understood that outer diagonal thickness 230 and inner diagonal thickness 232 measurements shown in FIG. 2E are for illustrative purposes only and that any other suitable wheel measurements or relative measurements could be used in conjunction with or in lieu of outer diagonal thickness 230 and inner diagonal thickness 232 measurements according to one embodiment of the present disclosure.

In the embodiments shown in FIGS. 2A and 2E, outer diagonal thickness 230 is generally a measurement of the thickness of outer seat 218. In one example, outer diagonal thickness 230 could be the distance between a proximate surface of outer seat 218 and a distal surface of outer seat 218. It should be understood that outer diagonal thickness 230 could be an average or mean value of several such measurements taken at different points about wheel 202 and outer seat 218, a maximum thickness measured, a minimum thickness measured, or some other correlated value related to such measurements.

Similarly, as also shown in FIGS. 2A and 2E, inner diagonal thickness 232 is generally a measurement of the thickness of inner seat 220. In one example, inner diagonal thickness 232 could be the distance between a proximate surface of inner seat 220 and a distal surface of inner seat 220. It should be understood that inner diagonal thickness 232 could be an average or mean value of several such measurements taken at different points about wheel 202 and inner seat 220, a maximum thickness measured, a minimum thickness measured, or some other correlated value related to such measurements.

FIG. 2F is a cross-sectional view of wheel 202 illustrating where outer surface run-out 234 and inner surface run-out 236 measurements could be taken according to one embodiment of the present disclosure. It should be understood that surface run-out 234 and inner surface run-out 236 measurements shown in FIG. 2F are for illustrative purposes only and that any other suitable wheel measurements or relative measurements could be used in conjunction with or in lieu of outer surface run-out 234 and inner surface run-out 236 measurements according to one embodiment of the present disclosure.

In the embodiments shown in FIGS. 2A and 2F, outer surface run-out 234 is generally a measurement of the “roundness” of the outer side of wheel 202 and could be taken between outer lip 208 and outside bead 212 proximate to outside seat 218. For example, outer surface run-out 234 measurements could be related to the total displacement of wheel 202 with respect to an outer surface of a tire disposed about wheel 202. It should be understood that outer surface run-out 234 could be an average or mean value of several such measurements taken at different points about wheel 202 and proximate to outer seat 218, a maximum run-out value measured, a minimum run-out value measured, or some other correlated value related to such measurements.

Similarly, as also shown in FIGS. 2A and 2F, inner surface run-out 236 is generally a measurement of the “roundness” of the inner side of wheel 202 and could be taken between inner lip 210 and inner bead 214 proximate to inner seat 220. For example, inner surface run-out 236 measurements could be related to the total displacement of wheel 202 with respect to an inner surface of a tire disposed about wheel 202. It should be understood that inner surface run-out 236 could be an average or mean value of several such measurements taken at different points about wheel 202 and proximate to inner seat 220, a maximum run-out value measured, a minimum run-out value measured, or some other correlated value related to such measurements.

In one embodiment, system 100 shown in FIG. 1 could use information related to, for example, the manufacturer of wheel 202, size/dimension of wheel 202, model year of the vehicle associated with wheel 202, manufacturing date, repair date, model name, a serial number of wheel 202, an assigned serial number of wheel 202, other suitable information related to wheel 202, or any combination thereof to ascertain the overall condition of wheel 202.

As generally illustrated in FIGS. 2C-2F, system 100 could also include determining or otherwise using one or more of the following: outer radial thickness 222, inner radial thickness 224, outer lateral thickness 226, inner lateral thickness 228, outer diagonal thickness 230, inner diagonal thickness 232, outer surface run-out 234, inner surface run-out 236, other suitable information, measurements, dimensions, or other elements, or any combination thereof according to one embodiment of the present disclosure.

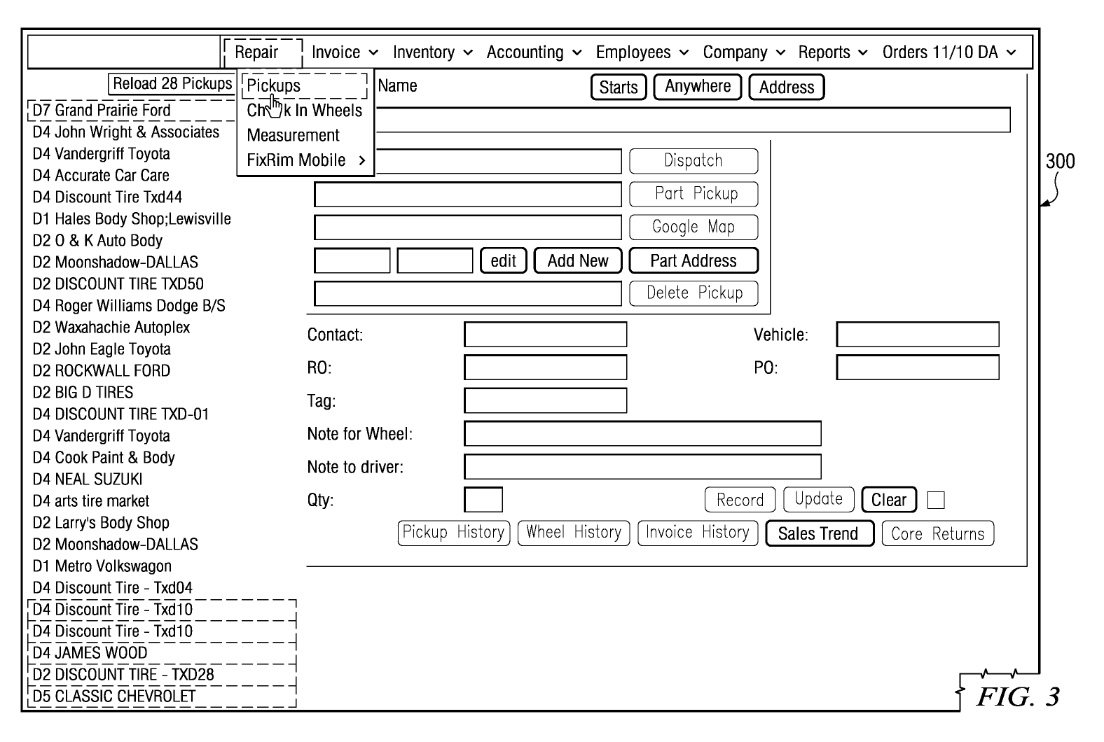

FIG. 3 is a somewhat simplified illustration of graphical user interface (GUI) 300 showing exemplary list 402 of wheels associated with particular manufacturers currently in an example database according to one embodiment of the present disclosure. It should be understood that GUI 300 shown in FIG. 3 is for illustrative purposes only and that any other suitable system, subsystem, or GUI could be used in conjunction with or in lieu of GUI 300 according to one embodiment of the present disclosure.

GUI 300 could include the ability to access certain information stored in system 100. For example, system 100 could include information on various wheels organized by type of vehicle, type of wheel, manufacturer, model numbers, serial numbers, or any combination thereof. System 100 could parse such information and include the ability to access a particular wheel type or information related to a particular wheel type according to one embodiment of the present disclosure. As an example, suppose that a user of system 100 wanted to access wheel information related to a particular wheel manufacturer. Using a menu-driven access system, GUI 300 could provide an interface to find such information. In one embodiment, the user, for example, could use a drop-down menu system to choose a desired wheel or wheel manufacturer.

Assuming that the wheel's information is indeed included in database 106, then the user would access information associated with that wheel. For example, database 106 could include information such as acceptable tolerances for outer radial thickness 222, inner radial thickness 224, outer lateral thickness 226, inner lateral thickness 228, outer diagonal thickness 230, inner diagonal thickness 232, outer surface run-out 234, inner surface run-out 236, other suitable information, or any combination thereof (as generally shown in FIGS. 2C-2F) according to one embodiment of the present disclosure. In one embodiment, acceptable requirements or tolerances for these measurements (or wheel characteristics) could be determined by a manufacturer or other entity on a wheel-by-wheel basis or based on an industry standard. A user could accordingly, depending on the acceptable tolerances, determine whether a particular wheel has met such tolerances and could standup to further surface treatments as later described in detail herein in conjunction with the description accompanying FIG. 5.

In first example, suppose that the user measures and inputs the measurement of outer diagonal thickness 230 associated with wheel 202. Suppose further that this measurement is below the minimum threshold requirement or tolerance allowable for the outer diagonal thickness of the bead or average diagonal thickness of the bead for that particular wheel or family of wheels. Then, in this example, system 100 could correlate the data and determine that the wheel could not be repaired safely.

Suppose, in second example, that wear-and-tear of a particular wheel is not so severe as in the previous example. In this example, suppose further that the user measures and inputs the measurement of outer diagonal thickness 230 associated with wheel 202 and this measurement is within the minimum threshold requirement or tolerance allowable for the diagonal thickness of the bead or average outer diagonal thickness for that particular wheel or family of wheels. However, when the wheel is repaired sufficiently and the wheel surface is sanded down appropriately, for example, the resulting diagonal thickness would not be within the acceptable tolerance range. Then, in this example, system 100 could correlate the data and determine that the wheel could not be repaired safely.

Suppose, in a third example, that wear-and-tear of a particular wheel is not so severe as in the previous examples. The user measures and inputs the measurement of outer diagonal thickness 230 associated with wheel 202. Further, suppose this measurement is within the minimum threshold requirement or tolerance allowable for the outer diagonal thickness of the bead or average outer diagonal thickness of the bead for that particular wheel or family of wheels. Additionally, when the wheel is repaired sufficiently and the wheel surface is sanded down appropriately, for example, the resulting diagonal thickness would still remain within the acceptable tolerance range. Then, in this example, system 100 could correlate the data and determine that the wheel could be repaired safely.

Accordingly, in one embodiment, system 100 could determine an average measurement of a standard characteristic of a wheel, compare that measurement with a desired, predetermined, or database value, and determine whether a wheel may be repairable. In one embodiment, system 100 determines the reparability of a wheel based on the current condition of the wheel, average or ideal measurements of certain characteristics of the wheel, and available tolerances to repair the wheel.

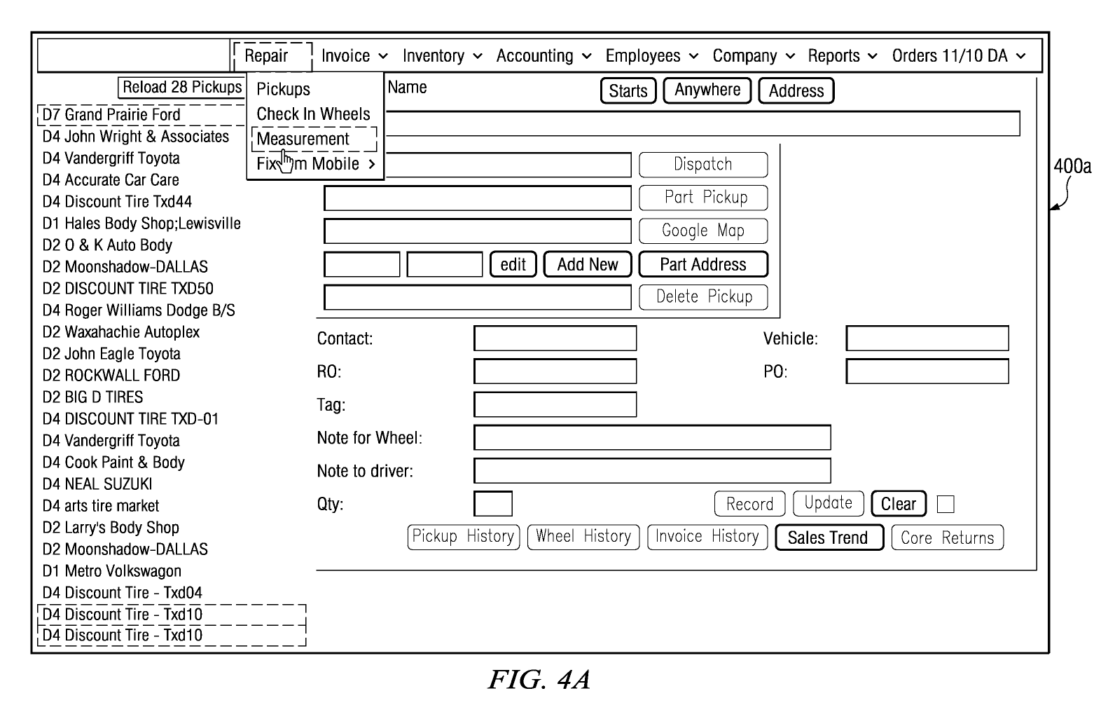

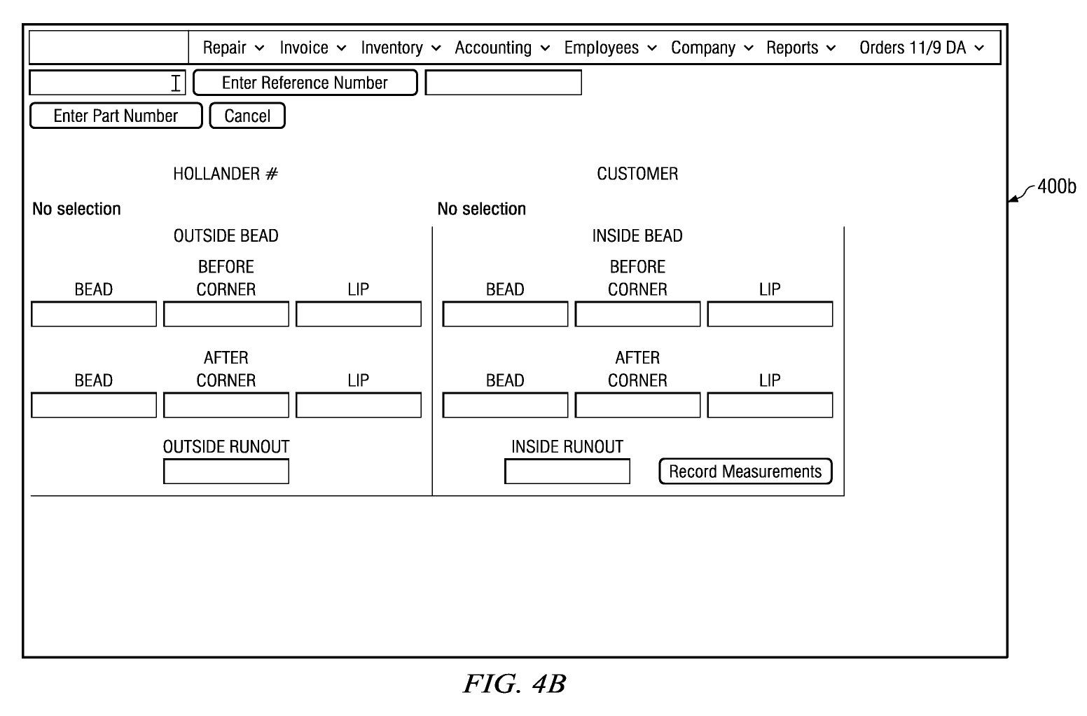

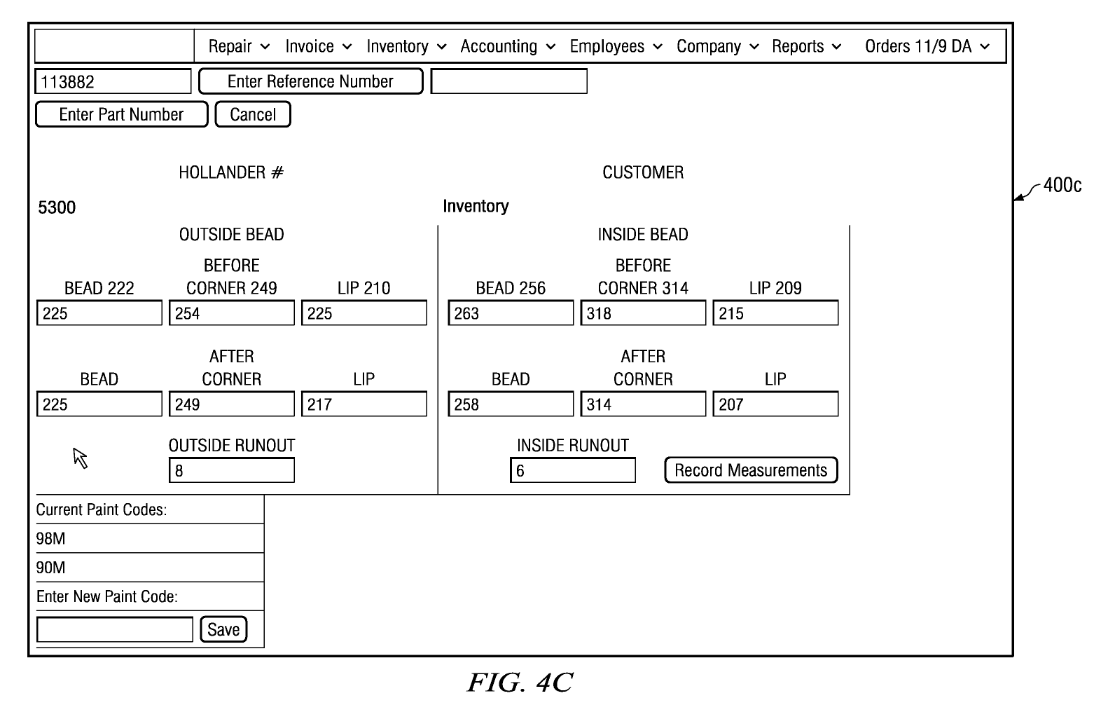

If a particular wheel's information is not available through database 106, for example, the user could use GUI 400 to input the wheel's information into system 100 as shown in FIGS. 4A, 4B, and 4C. The inputted information could be stored in database 106 and accessed by network 108 and terminal 102 according to one embodiment of the present disclosure.

FIGS. 4A-4C are somewhat simplified illustrations of GUI 400a, 400b, and 400c (sometimes collectively referred to herein as GUIs 400) used by a technician to enter various technical information for a desired wheel according to one embodiment of the present disclosure. It should be understood that GUIs 400 shown in FIGS. 4A-4C are for illustrative purposes only and that any other suitable system, subsystem, or GUI could be used in conjunction with or in lieu of GUIs 400 according to one embodiment of the present disclosure.

GUIs 400 illustrate an example input form to provide technical information for a desired wheel according to one embodiment of the present disclosure. FIG. 4A illustrates an input form to include owner information for a particular wheel. GUI 400a could include, for example, a data entry box for customer name, contact information, wheel type, vehicle identification number, other suitable customer or wheel related information, or any combination thereof.

FIG. 4B illustrates an input form to include technical information for a particular wheel. GUI 400a could include, for example, a data entry box for technical wheel data such as, for example, outer radial thickness 222, inner radial thickness 224, outer lateral thickness 226, inner lateral thickness 228, outer diagonal thickness 230, inner diagonal thickness 232, outer surface run-out 234, inner surface run-out 236, other suitable information, or any combination thereof according to one embodiment of the present disclosure.

FIG. 4C illustrates GUIs 400 with data entry boxes completed with measured technical data. In one embodiment, once the technical data is input, then system 100 could store the data in database 106. System 100 could also correlate the data, compute averages where necessary, and compare the correlated data to acceptable levels stored in database 106. Based on the comparison, system 100 could determined whether the wheel is repairable and whether, after such repairs are complete, the wheel would still meet certain tolerances or measurements and thus be repaired while complying to safety requirements.

FIG. 5 is a somewhat simplified flow diagram illustrating method 500 of determining and correlating technical information for wheel repairs according to one embodiment of the present disclosure. It should be understood that method 500 shown in FIG. 5 is for illustrative purposes only and that any other suitable method or sub-method could be used in conjunction with or in lieu of method 500 according to one embodiment of the present disclosure. It should be understood that the steps of method 500 could be performed in any suitable manner and in any suitable order according to one embodiment of the present disclosure.

Step 502 could include determining whether a particular wheel, wheel type, family, model, serial number, or manufacture is included in a system database according to one embodiment of the present disclosure. For example, method 500 could include querying a database such as, for example, database 106 (shown in FIG. 1) through the use of a graphical use interface such, as for example, GUIs 300 and 400 (shown in FIGS. 3, 4A, 4B, and 4C) for a particular wheel such as, for example, wheel 202 (shown in FIGS. 2A-2F). In one embodiment, the query could include queries for information related to the manufacturer of the wheel, size/dimension of wheel 202, manufacturing date, model name, and serial number of wheel 202, control data, or any combination thereof. The query could include querying databases associated with terminal 102, processor 104, database 106, network 108, or any combination thereof.

If in step 502, method 500 determines that there is no match to the query, then method 500 continues with step 504. The user inputs ideal, control data, or manufacturer information and any relevant technical information into system 100 and saves the information in database 106. The technical information could include, for example, outer radial thickness 222, inner radial thickness 224, outer lateral thickness 226, inner lateral thickness 228, outer diagonal thickness 230, inner diagonal thickness 232, outer surface run-out 234, inner surface run-out 236, other suitable information related to wheel 202, or any combination thereof according to one embodiment of the present disclosure. Method 500 could then continue with step 506.

If, on the other hand, in step 502, method 500 determines that there is a match to the query and wheel technical information is available, then method 500 continues with step 506. In step 506, the user could select the wheel from the query results and system 100 could use the corresponding information to compare similar information with wheel 202.

Method 500 could continue with step 508. The user takes and inputs measurement corresponding to wheel 202 into system 100. The measurements could be taken manually or through a computerized system that ascertains measurements of wheel 202. The measurements could include, for example, outer radial thickness 222, inner radial thickness 224, outer lateral thickness 226, inner lateral thickness 228, outer diagonal thickness 230, inner diagonal thickness 232, outer surface run-out 234, inner surface run-out 236, other suitable information related to wheel 202, or any combination thereof according to one embodiment of the present disclosure.

After inputting technical data related to wheel 202, method 500 continues with step 510. Step 510 could include storing, correlating, analyzing, and comparing the technical information inputted into system 100 with the ideal or manufacturer related information for the corresponding wheel selected in step 506.

In step 512, method 500 determines whether the measurements (or an average of the measurements) are within a certain tolerance level and wheel 202 is repairable. If the measurements fail to meet the tolerance level, then wheel 202 is not repairable.

Method 500 could therefore provide a method for determining the general integrity and reparability of the wheel in an effective, efficient, and cost-sensitive manner according to one embodiment of the present disclosure.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system of repairing a wheel, the system comprising:
a terminal to input data associated with a bead of the wheel; and
a processor to correlate the inputted data with control data stored in a database, wherein the processor determines the reparability of the wheel based on the correlated data.

2. The system of claim 1, wherein the input data comprises at least one of: an outer radial thickness of the wheel and an inner radial thickness of the wheel.

3. The system of claim 1, wherein the input data comprises a lateral thickness of the bead.

4. The system of claim 1, wherein the input data comprises at least one of: an outer diagonal thickness of the wheel and an inner diagonal thickness of the wheel.

5. The system of claim 1, wherein the input data comprises at least one of: an inner surface run-out measurement and an outer surface run-out measurement.

6. The system of claim 1 further comprising:
an Internet network in communication with the terminal, the database, and the processor.

7. The system of claim 1 further comprising:
a wireless network in communication with the terminal, the database, and the processor.

8. The system of claim 1, wherein the control data comprises manufacturer recommended specifications related to the bead.

9. The system of claim 1, wherein the terminal comprises a graphical user interface (GUI) to input the data associated with the bead.

10. A method of determining the reparability of a wheel, the method comprising:
determining the control data associated with a bead of the wheel;
measuring technical data associated with a surface of the wheel and the bead;
comparing the control data with the measured technical data; and
determining the reparability of the wheel based on the comparison.

11. The method of claim 10, wherein the measuring comprises measuring at least one of: an outer radial thickness of the wheel and an inner radial thickness of the wheel.

12. The method of claim 10, wherein the measuring comprises measuring a lateral thickness of the bead.

13. The method of claim 10, wherein the measuring comprises measuring at least one of: an outer diagonal thickness of the wheel and an inner diagonal thickness of the wheel.

14. The method of claim 10, wherein the measuring comprises measuring at least one of: an outer surface run-out measurement of the wheel and an inner surface run-out measurement of the wheel.

15. The method of claim 10 further comprising:
using an Internet network to access the control data.

16. The method of claim 10 further comprising:
using a wireless network to access the control data.

17. The method of claim 10, wherein the control data comprises manufacturer recommended specifications related to the bead.

18. A system of determining the reparability of a wheel, the system comprising:
a graphical user interface (GUI) to input data associated with the wheel, wherein the input data comprises information associated with a lateral thickness of a bead of the wheel and a surface run-out measurement of the wheel;
a network having a database to store the inputted data and having control data associated with the wheel; and
a processor in communication with the database to correlate the input data with the control data and to determine the reparability of the wheel.

19. The system of claim 18, wherein the input data comprises at least one of: an outer radial thickness of the wheel and an inner radial thickness of the wheel.

20. The system of claim 18, wherein the input data comprises at least one of: an outer diagonal thickness of the wheel and an inner diagonal thickness of the wheel.
